(19) United States
(12) Patent Application Publication
(10) Pub. No.: US 2025/0214875 A1
(43) Pub. Date: Jul. 3, 2025

(54) SYSTEM AND METHOD FOR INJECTING ACTIVATED CARBON INTO AN UNDERGROUND WATER AQUIFER.

(71) Applicant: Christopher L Abeyta, FARMINGTON, NM (US)

(72) Inventor: Christopher L Abeyta, FARMINGTON, NM (US)

(21) Appl. No.: 18/401,632

(22) Filed: Jan. 1, 2024

(51) Int. Cl. C02F 1/68; C02F 101/36; C02F 103/06

(52) U.S. Cl. CPC C02F 1/687; C02F 2101/36; C02F 2103/06

(57) ABSTRACT

A system and method may comprise; retrofitting a pump jack to provide the mechanical force to operate a positive displacement reciprocating slurry pump or pumps to inject activated carbon into any region or area within an underground water aquifer for prevention or capture for remediation of man-made chemicals known and referred to PFAS “Forever Chemical”

### FIELD OF INVENTION

The subject of this disclosure may relate generally to systems, devices, and methods to retrofit a pump jack to supply the mechanic force needed to operate a positive displacement reciprocating pump or pumps for injecting activated carbon slurry into aquifers for prevention or capture for remediation of man-made chemicals known and referred to PFAS “Forever Chemical. Worldwide, 97% of the planet's liquid fresh water is stored in aquifers. Major aquifers are tapped on every continent, and groundwater is the primary source of drinking water for more than 1.5 billion people worldwide.

### BACKGROUND OF THE INVENTION

There is a growing concern, now international in scope, over the contamination of PFAS, also known as “forever chemicals” in drinking water all over the world. Forever chemicals are widely used, long lasting chemicals, components of which down very slowly over time.

Because of their widespread use and their persistence in the environment, many PFAS are found in the blood of people and animals all over the world and are present at low levels in a variety of food products and in the environment.

PFAS are found in water, air, fish, and soil at locations across the nation and the globe.

Scientific studies have shown that exposure to some PFAS in the environment may be linked to harmful health effects in humans and animals.

There are thousands of PFAS chemicals, and they are found in many different consumer, commercial, and industrial products. This makes it challenging to study and assess the potential human health and environmental risks.

It is in the above-explained context that this patent application is being submitted to the Patent Office, with the intent of offering methods, systems and devices for an immediate and effective solution to inject activated carbon slurry to any location in an aquifer for prevention or remediation to capture and permanently sequester PFAS's in drinking water.

### SUMMARY OF THE INVENTION

One method is disclosed herein. In various embodiments, the method comprises: retrofitting a pump jack to provide the required mechanical force to operate a single or multi-stage positive displacement reciprocating slurry pump or pumps to inject activated carbon into aquifers from new, existing or abandoned wells commonly used in the oil and gas industry.

In various embodiments, the system in the method can comprise; designing specific volumes and pressures for the slurry pump to inject into targeted regions or areas within the aquifer.

In various embodiments, the system in the method can comprise; designing specific volumes and pressures to inject powdered activated carbon with colloidal properties or any determined particle sizes in slurry or with colloidal properties into targeted regions or areas within the aquifer.

### BRIEF DESCRIPTION OF THE DRAWINGS

These and other features, aspects, and advantages will become better understood with reference to the following description, claims and accompanying drawings where:

FIG. 1 illustrates a side view of the devices in the exemplary embodiment in accordance with various embodiments; a positive displacement reciprocating slurry pump for injection of activated carbon slurry.

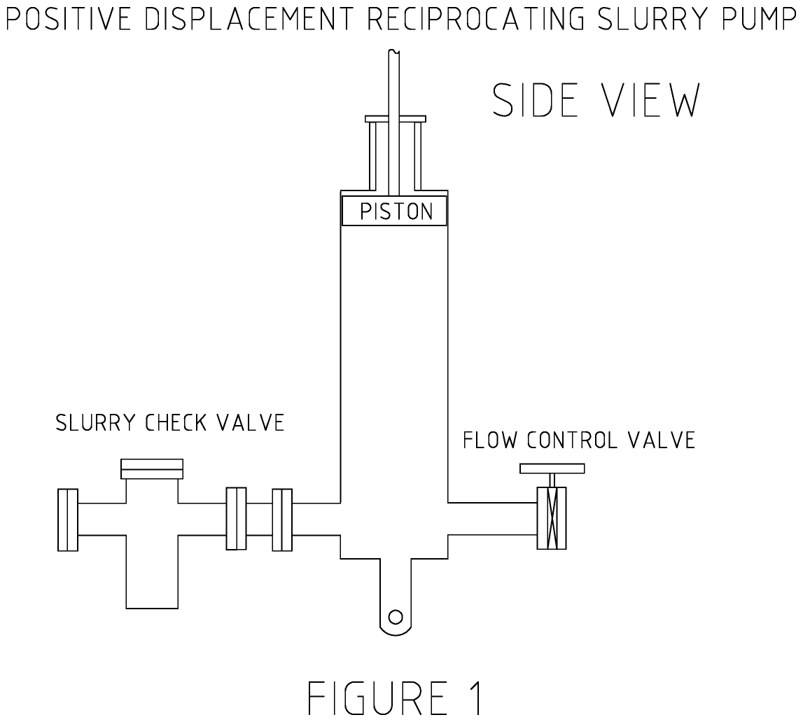

FIG. 2 illustrates a side view of the devices in the exemplary embodiment in accordance with various embodiments; a retrofitted pump jack, positive displacement reciprocating slurry pump for injection of activated carbon slurry.

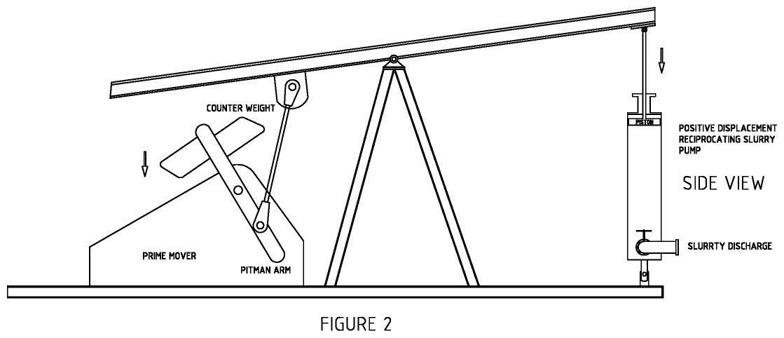

FIG. 3 illustrates a top view of the system and method in the exemplary embodiment in accordance with various embodiments; a retrofitted pump jack skid, power solar array and activated carbon slurry storage tank for injection of activated carbon slurry.

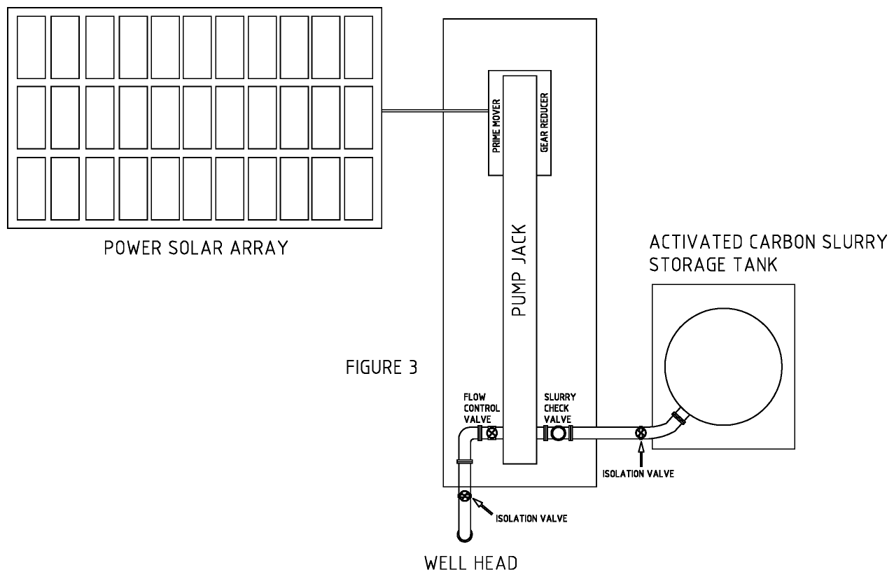

### DETAILED DESCRIPTION

In accordance with the exemplary embodiments of the present invention, systems, methods and devices are not intended as a limitation on the use or applicability of the invention, but instead, are provided merely to enable a full and complete description of the exemplary embodiments.

It should be appreciated that the particular implementations shown and described herein are illustrative of various embodiments including its best mode and are not intended to limit the scope of the present disclosure in any way or are intended to represent all exemplary functional relationships possible.

While the principles of the disclosure have been shown in embodiments, many modifications of structure, arrangements, proportions, devices, materials and components, used in practice, which are particularly adapted for a specific environment and operating requirements without departing from the principles and scope of this disclosure. These and other changes or modifications are intended to be included within the scope of the present disclosure and may be expressed in the following claims.

We claim:

1. An apparatus comprising:
a retrofitted pump jack to provide the mechanical force to drive a single or multiple positive displacement reciprocating slurry pump to inject activated carbon into water aquifers.

2. The apparatus of claim 1, wherein the retrofitted pump jack is configured with a slurry check valve to avoid back pressure generated from the positive displacement reciprocating slurry pump.

3. A method comprising:
a renewable energy source to provide the required energy for the prime mover of retrofitted pump jack to inject activated carbon in any region or areas within an underground water aquifer.

4. The method of claim 3, wherein the activated carbon is slurry

5. The method of claim 3, wherein the activated carbon may be formulated to contain colloidal properties for pumping.

6. A system comprising:
delivering an activated carbon into any region or area within an underground aquifer for prevention or capture for remediation of man-made chemicals known and referred to PFAS “Forever Chemicals”.

7. The system of claim 6, further comprising:
delivering an activated carbon into any region or area within an underground aquifer for treatment of brackish water for pre-treatment of drinking water and agricultural water sources.

8. A system according to claim 6, wherein the compounds include can identify PFOA and PFOS as individual contaminants, and PFHxS, PFNA, PFBS, Gen-X.
